(19) United States
(12) Patent Application Publication
(10) Pub. No.: US 2015/0150415 A1
(43) Pub. Date: Jun. 4, 2015

(54) Barbecue Grill with Collapsible Legs

(71) Applicant: Kiosky CHUNG, Taichung (TW)

(72) Inventor: Kiosky CHUNG, Taichung (TW)

(21) Appl. No.: 14/094,619

(22) Filed: Dec. 2, 2013

(51) Int. Cl. A47J 37/07

(52) U.S. Cl. CPC A47J 37/0763

(57) ABSTRACT

A portable barbecue grill includes a bowl, four legs and four connecting units each for connecting a corresponding one of the legs to the bowl in a collapsible manner. Each of the legs includes an aperture. Each of the connecting units includes a pin for insertion in the aperture of a corresponding one of the legs to keep the legs in an extended position.

### BACKGROUND OF INVENTION

1. Field of Invention

The present invention relates to a portable barbecue grill and, more particularly, to a portable barbecue grill with collapsible legs.

2. Related Prior Art

There are various barbecue grills. Some of them are large and equipped with wheels for movement. Some others of them are small and portable without the use of wheels. In use, the portable barbecue grills are generally laid on the ground, with people sitting on short stools or chairs around them.

Some of the portable barbecue grills are equipped with short and non-collapsible legs. The short legs make it easy to transport the portable barbecue grills. However, short legs lift the barbecue grills to insufficient height, and hence render it tiresome to cook. Long legs are used to lift the portable barbecue grills to adequate height to render it less tiresome to cook. However, the long legs render it difficult to store the portable barbecue grills.

Therefore, the present invention is intended to obviate or at least alleviate the problems encountered in prior art.

### SUMMARY OF INVENTION

It is the primary objective of the present invention to provide a comfortable-to-use and convenient barbecue grill.

To achieve the foregoing objective, the portable barbecue grill includes a bowl, four legs and four connecting units each for connecting a corresponding one of the legs to the bowl in a collapsible manner.

In an aspect, each of the legs includes an aperture. Each of the connecting units includes a pin for insertion in the aperture of a corresponding one of the legs to keep the legs in an extended position.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a perspective view of a portable barbecue grill with collapsible legs according to the preferred embodiment of the present invention;

FIG. 2 is a partial and exploded view of the portable barbecue grill shown in FIG. 1;

FIG. 3 is a partial and cross-sectional view of the portable barbecue grill shown in FIG. 1;

FIG. 4 is a front view of the portable barbecue grill illustrated in FIG. 1; and

FIG. 5 is a front view of the portable barbecue grill in another position than shown in FIG. 4.

### DETAILED DESCRIPTION OF PREFERRED EMBODIMENT

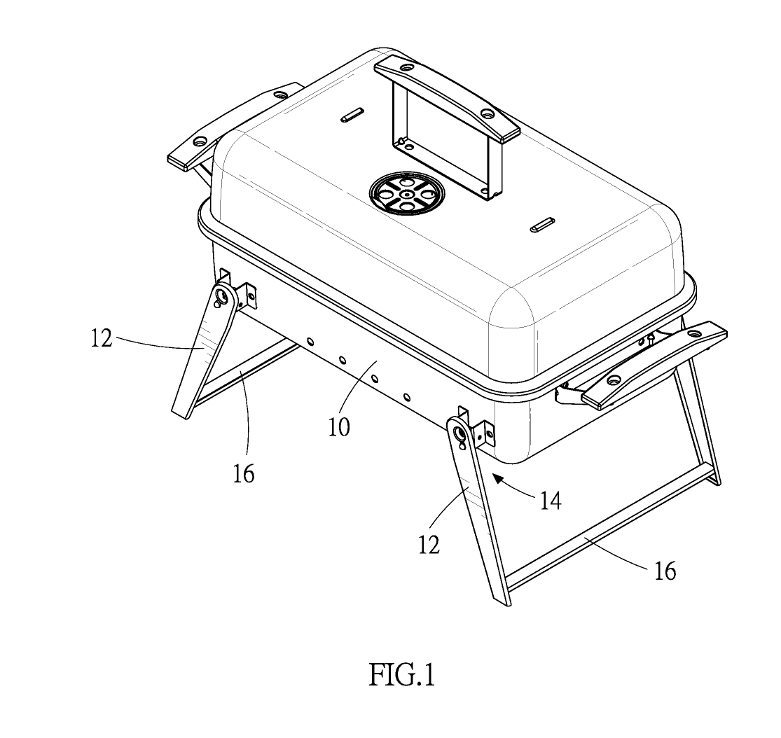

Referring to FIG. 1, there is a portable barbecue grill according to the preferred embodiment of the present invention. The portable barbecue grill includes a bowl 10, four legs 12 and four connecting units 14 for connecting the legs 12 to the bowl 10 in a collapsible manner.

The four legs 12 are classified into two left legs 12 and two right legs 12. A bar 16 is used to interconnect the left legs 12. Thus, the left legs 12 are operable as a whole and it is therefore convenient to maneuver them. Moreover, buckling of the left legs 12 from each other is avoided and the left legs 12 are hence reliable. Similarly, another bar 16 is used to interconnect the right legs 12. Each of the legs 12 includes a large aperture 18 and a small aperture 20.

Each of the connecting units 14 includes a major supporting element 22, a minor supporting element 24, a pin 26 and a spring 28. The major supporting element 22 includes a middle transverse portion, two lateral transverse portions, and two longitudinal portions each extending to the middle transverse portion from a corresponding one of the lateral transverse portions. The middle transverse portion includes a large aperture 30 corresponding to the large aperture 18 and a small aperture 32 corresponding to the smaller aperture 20. Each of the lateral transverse portions includes an aperture 34. Each of the longitudinal portions includes an aperture 36. The spring 28 is a helical spring.

The minor supporting element 24 includes a transverse portion formed between two longitudinal portions. The transverse portion of the minor supporting element 24 includes an aperture 38. Each of the longitudinal portions of the minor supporting element 24 includes an aperture 40.

The pin 26 includes an annular rib 42 extending between two portions. The portions of the pin 26 may be made of a same diameter or different diameters. The pin 26 is formed with a rounded end 44.

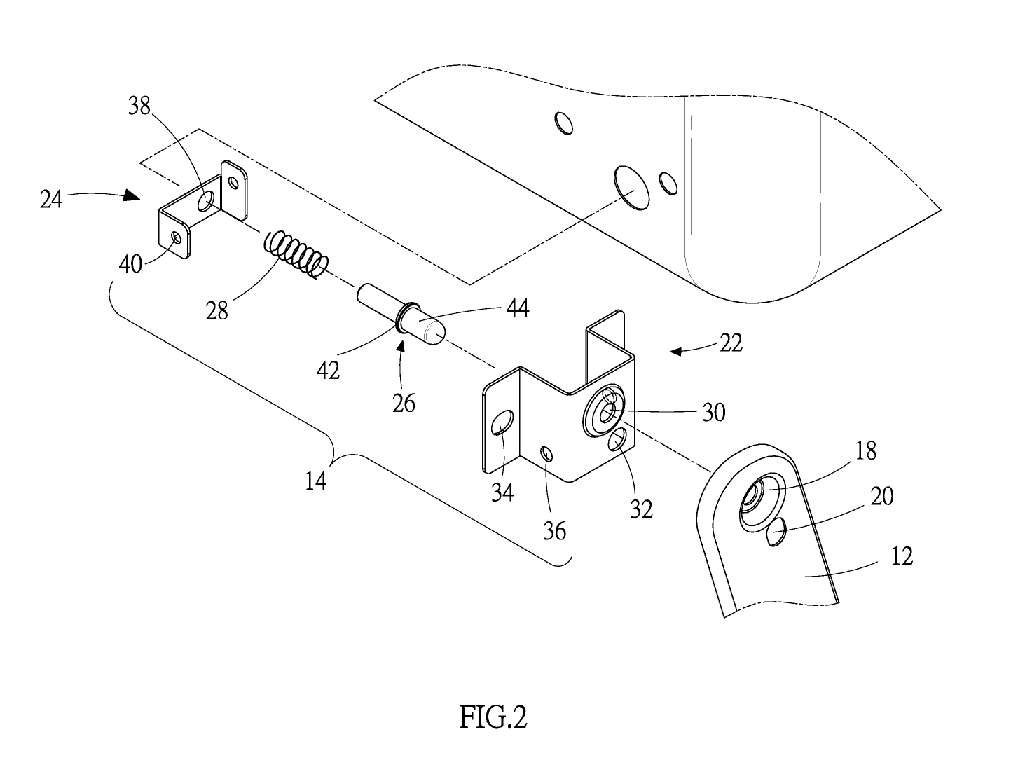

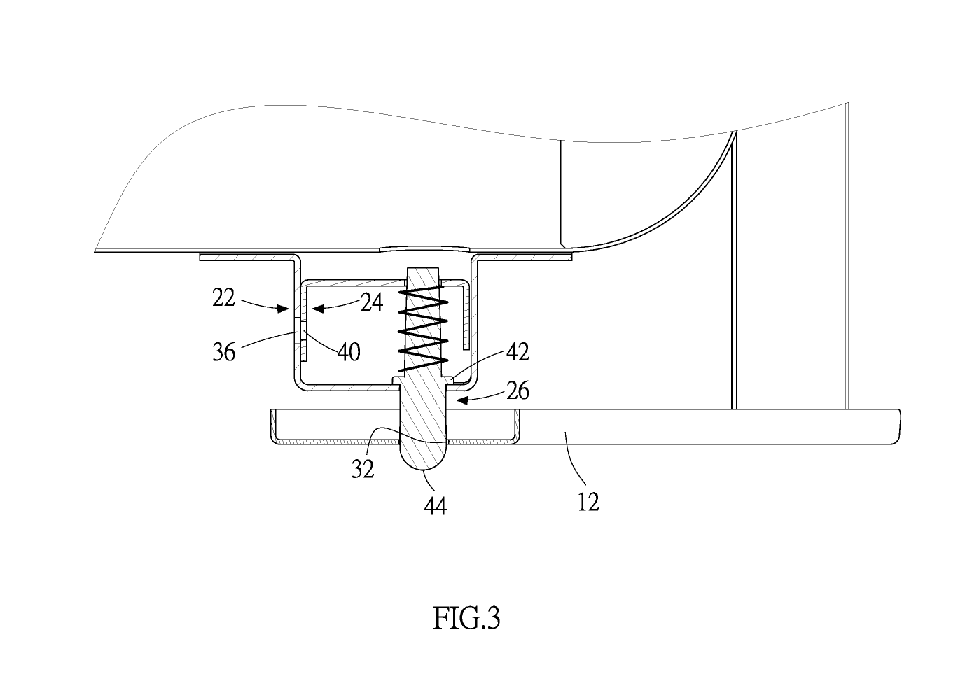

Referring to FIGS. 2 and 3, the major supporting element 22 is secured to the bowl 10 by inserting a fastener such as a rivet or a screw (not shown) in the bowl 10 via the aperture 34 of each lateral transverse portion of the major supporting element 22. The leg 12 is pivotally connected to the major supporting element 22 by inserting a fastener such as rivet or a screw (not shown) in the apertures 18 and 32.

The minor supporting element 24 is secured to the major supporting element 22 by inserting a fastener such as rivet or a screw (not shown) in the aperture 40 of each longitudinal portion of the minor supporting element 24 and the aperture 36 of a corresponding longitudinal portion of the major supporting element 22. The first portion of the pin 26 is inserted in the aperture 32. The second portion of the pin 26 is inserted in the spring 28. The spring 28 is compressed between the annular rib 42 and the transverse portion of the minor supporting element 24 to bias the rounded end 44 of the pin 26 toward the leg 12.

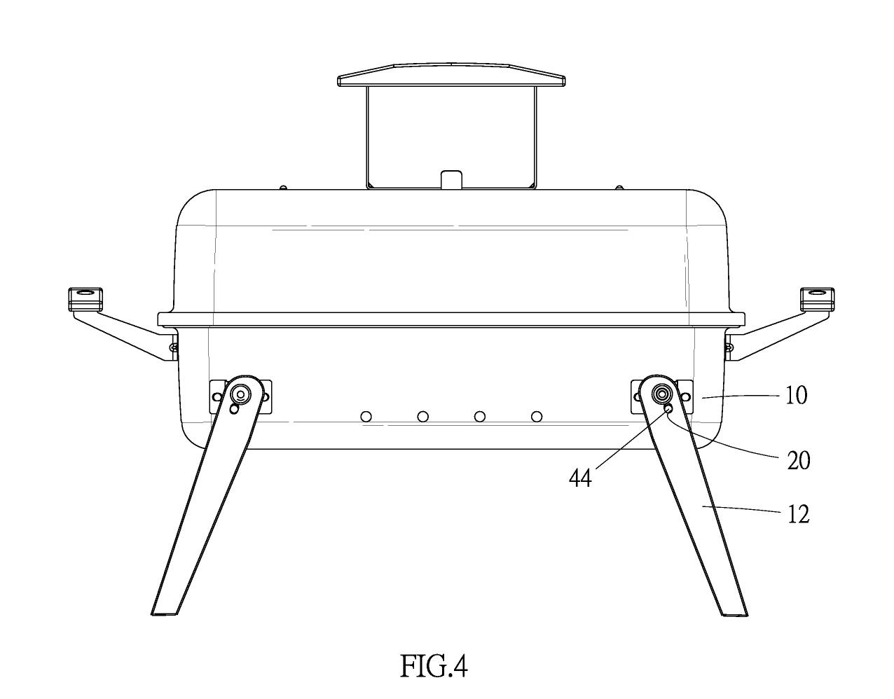

Referring to FIGS. 3 and 4, the legs 12 are in an extended position. The rounded end 44 of the pin 26 of each connecting unit 14 is inserted in the small aperture 20 of a corresponding leg 12. Thus, the legs 12 are kept in the extended position by the connecting units 14.

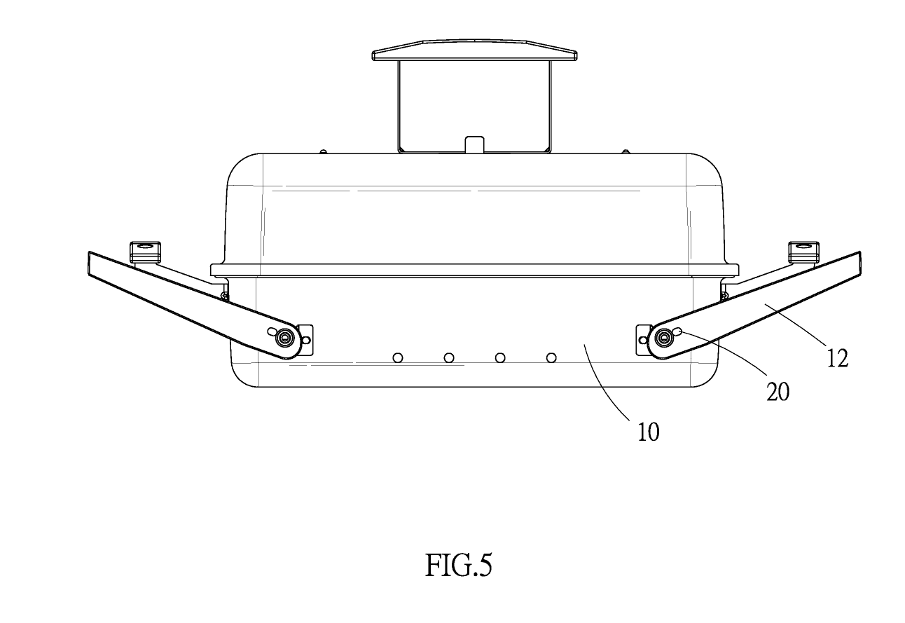

The rounded end 44 of the pin 26 of each connecting unit 14 is pushed out of the small aperture 20 of the corresponding leg 12. Then, the legs 12 are pivoted into a collapsed position referring to FIG. 5.

The present invention has been described via the detailed illustration of the preferred embodiment. Those skilled in the art can derive variations from the preferred embodiment without departing from the scope of the present invention. For example, there may be only two connecting units 14, one for one of the left legs 12, which are interconnected by a bar 16, and the other for one of the right legs 12, which are interconnected by another bar 16. Therefore, the preferred embodiment shall not limit the scope of the present invention defined in the claims.

1. A portable barbecue grill including
a bowl;
four legs; and
four connecting units each for connecting a corresponding one of the legs to the bowl in a collapsible manner.

2. The portable barbecue grill according to claim 1, wherein each of the legs includes an aperture, wherein each of the connecting units includes a pin for insertion in the aperture of the corresponding leg to keep the legs in an extended position.

3. The portable barbecue grill according to claim 2, wherein each of the connecting units includes a spring for biasing the pin toward the corresponding leg.

4. The portable barbecue grill according to claim 3, wherein each of the connecting units includes a major supporting element secured to the bowl and a minor supporting element secured to the major supporting element, wherein the pin are movably supported on the major and minor supporting elements.

5. The portable barbecue grill according to claim 4, wherein the major supporting element includes an aperture for receiving a portion of the pin, wherein the minor supporting element includes an aperture for receiving another portion of the pin.

6. The portable barbecue grill according to claim 5, wherein the major supporting element includes a middle transverse portion formed with the aperture, two lateral transverse portions secured to the bowl, and two longitudinal portions each extending to the middle transverse portion from a corresponding one of the lateral transverse portions, wherein the minor supporting element includes a transverse portion formed with the aperture and two longitudinal portions secured to the longitudinal portions of the major supporting element.

7. The portable barbecue grill according to claim 5, wherein the spring is compressed between the minor supporting element and the pin.

8. The portable barbecue grill according to claim 7, wherein the pin includes an annular rib placed against the spring.

9. The portable barbecue grill according to claim 8, wherein the spring is a helical spring placed around the pin and compressed between the annular rib and the minor supporting element.

10. The portable barbecue grill according to claim 1, including two bars each for interconnecting two corresponding ones of the legs.
